(19) United States
(12) Patent Application Publication
(10) Pub. No.: US 2005/0080667 A1
(43) Pub. Date: Apr. 14, 2005

(54) System and method for automated customized content delivery for web sites

(75) Inventors: Benjamin A. Knott, Round Rock, TX (US); Robert R. Bushey, Cedar Park, TX (US); Theodore B. Pasquale, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SBC Knowledge Ventures, L.P., Reno, NV (US)

(21) Appl. No.: 10/681,448

(22) Filed: Oct. 8, 2003

(51) Int. Cl. G06F 17/60

(52) U.S. Cl. 705/14

(57) ABSTRACT

A system and method for customizing commercial web content delivered to a user's web browser. The user's consumer demographic data and preferences are gathered and stored in a database. These preferences are matched to one of a number of stored customer models. The model is then matched to one of a number of web content alternatives, and that web content is used to compose the web site downloaded to the customer's web browser.

### TECHNICAL FIELD OF THE INVENTION

This invention relates to providing information over the Internet, and more particularly to customization of web site content to match customer models.

### BACKGROUND OF THE INVENTION

Web site design involves deciding on the content of the site, as well as how the content is to be presented. For commercial websites, a common practice in content selection is to base the design on specified business objectives or on an understanding of what the “typical” customer can effectively use. However, this practice is not optimal for web sites having diverse audiences whose users have widely different goals and objectives. In such cases, a single web site design may not meet the needs of, or even appeal to, a wide variety of users.

Some web sites permit users to customize their content, using their web browsers. This places the burden of customization on the user, who must add or delete content to suit his or her needs. Users may not be motivated to customize content on their own in this manner, especially for web sites they visit only infrequently.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for delivering customized web content in accordance with the invention.

FIG. 2 illustrates a method of delivering customized web content in accordance with the invention.

### DETAILED DESCRIPTION OF THE INVENTION

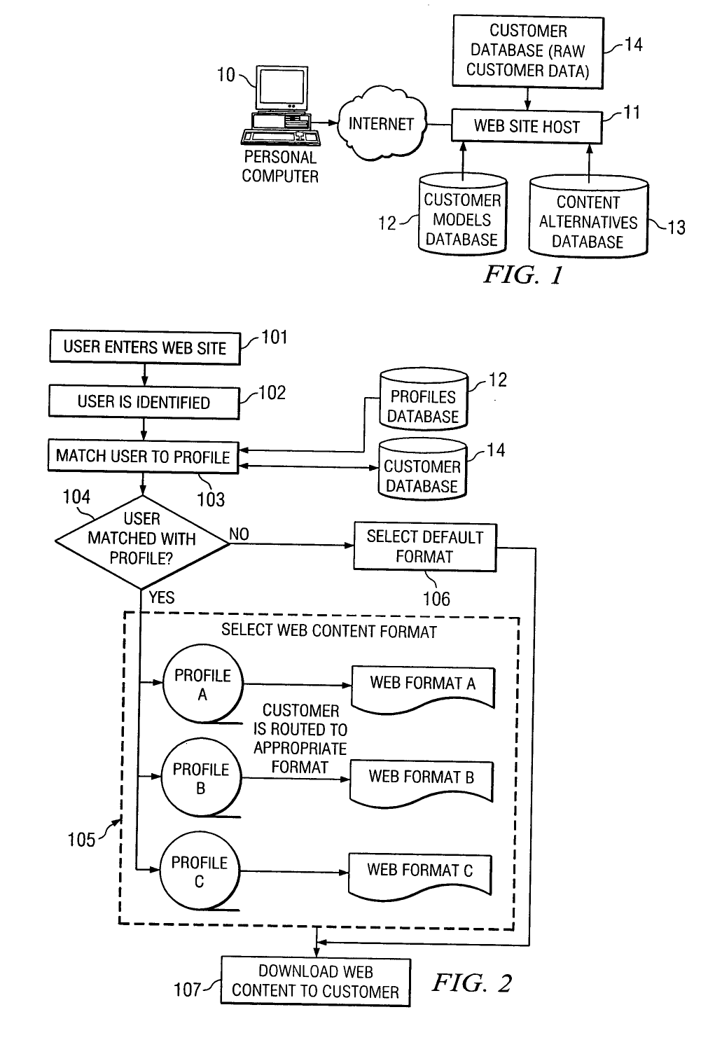

FIGS. 1 and 2 illustrate a system and method, respectively, for providing customized content for a web site in accordance with the invention. As explained below, the method applies a content selection capability to web sites, by matching customers with web site content that best meets the customer's preferences.

In the example of this description, the system and method are used by a web site provider that sells goods and services. The web site provider is referred to herein as an “e-commerce provider”. The e-commerce provider groups its customers into customer models. Each model is matched to the content alternative that is most effective for that group of customers.

Commercial enterprises other than merchandisers, who maintain web sites for the benefit of the public, could also be users of the system and method. The method of the invention may be applied for customization of all types of web site content, including product sales, as well as services such as repair, technical support, and troubleshooting.

The following scenario summarizes the operation of the customization method. For this scenario, it is assumed that the e-commerce provider has access to stored information about its customers in a database or other data source. Customer A rarely buys new services and tends to look for opportunities to reduce the overall cost of her bill. Customer A is identified by the e-commerce provider as being “cost focused”. The new sales potential for Customer A is low. When Customer A visits the e-commerce provider's website, content within the web site is organized to highlight ways to cut costs and reduce monthly bill payments. Customer B, on the other hand, is “technology focused”, and likes to have all the latest features and gadgets. The new sales potential for Customer B is high. When Customer B visits the e-commerce provider's web site, information on the viewed web page is organized to highlight the latest products and features. In this manner, the e-commerce provider customizes the web site's content to match specific types of customer's needs, thereby maximizing the business impact of the web site.

Referring specifically to FIG. 1, the customer accesses the e-commerce provider's web site by using a computing device 10 having web browser software or other programming for accessing the Internet. In the example of this description, computing device 10 is a personal computer. Other devices for accessing the Internet could be substituted for a personal computer, such as wireless hand held devices or laptops.

The e-commerce provider's web site is hosted by a web host 11, using known computing and data storage devices. In addition to conventional web site functionality, web host 11 is programmed with web site software that assigns each customer to an appropriate model, matches customer models to content, and downloads the appropriate content to the customer, as explained below in connection with FIG. 2.

The steps of assigning customers to models and matching the models to content may occur dynamically as the customer is on-line. This is especially appropriate for new visitors to the web site. Existing and/or returning customers may be already assigned and/or matched, in which case host 11 would store look up tables or similar lists.

Web host 11 is capable of accessing various data storage devices to fulfill download requests from browser programming on computer 10. For purposes of the present invention, the data storage devices include a customer “raw” data database 14, a customer models database 12, and content alternative database 13.

As explained below, the customer models database 12 stores data about past, current, or prospective customers of the e-commerce provider. Each customer's data is stored as a record, and represents at least data describing the customer's commercial preferences.

The “raw data” for customer models is stored in database 14. As an alternative to, or in supplement to database 14, customer data may be acquired in real time, as the customer is on-line to the web site. Thus, host 11 also has programming for harvesting information about customers while they are visiting the web site to be customized.

The customer data may include data gathered about the customer during contacts with the e-commerce provider's call center or its web site, or from third party data miners. Data that may be stored in the customer models database 12 includes age, gender, previous purchasing practices, previous navigation history, frequency of web site visits, internet service type (broadband, dial up, etc), browser type, socioeconomic status, and customer goal or task.

The customer data is used to develop customer models. Various customer types may be identified, based on an analysis of the customer data. These models represent predictive models of customer behavior.

In general, customer models use demographic or usage data to group customers into customer models. Each model is then used to provide similar content to all customers that fall within that model. Thus, customization is performed at a “model” level, rather than at an individual level.

An example of possible customer models is as follows:
Model A: savings focused; the customer goal is to find the best bargain.
Model B: cost focused; the customer goal is to minimize the overall bill amount.
Model C: technology focused; the customer goal is to acquire the most advanced features and functionality.

Web content database 13 stores content alternatives, from which a particular web site presentation may be composed. The content selections may be as “granular” as is desired by the e-commerce provider. In other words, the content selections may be simply “Page A” versus “Page B” or could be narrowed to “Paragraphs A, B, and C” versus “Paragraphs D, B, and C”.

The term “content” as used herein refers to both the literal information provided in the web site, as well as the content visual aspects, that is, its look and feel. The look and feel may include color scheme, graphics, fonts, layout, etc. For example, one content may be “flashy” by having more graphics, animation, and bright colors. Another content attribute might be the extent to which shortcuts are used. A different set of content attributes might be appropriate for elder customers, such as warmer colors, larger fonts, and more access to help menus. In other words, each customer model is matched to a content “persona”.

A number of different content alternatives are developed for one or more web pages of the web site. Each content alternative is optimized for a particular customer model, such that it maximizes the desired customer behavior. Thus, for an e-commerce provider, each content alternative maximizes the probability of an online sale for the matching customer model.

Optionally web content database 13 may also store a default format. If a customer cannot be matched to an appropriate model, the default format may be used for that customer.

FIG. 2 illustrates a method of using the system of FIG. 1. In Step 101, the customer enters the web site of the e-commerce provider. In Step 102, the customer is identified. Identification may be based on login information, an IP address, or any other identification method. Typically, the identification, for purposes of the model-content matching programming of host 11, is transparent to the customer. That is, the customer is not aware that he or she is being grouped into a model and that the model is being matched to a content alternative.

In Step 103, the data associated with the customer is matched to one of the models stored in database 12. As explained above, the model is consistent with the customer's goals and preferences.

In Step 104, it is determined whether Step 103 has resulted in a successful match. As explained below, this step determines whether customized content or a default content will be delivered to the customer.

Step 105 is performed if the customer is successfully matched to a model. If so, the model is then matched to web site content that is optimized for that model. This format presents web content in a manner that is predicted to be the most effective for the matching model. In other words, the content is likely to provide greater customer satisfaction, lower abandonment rates, and higher sales.

As an example, there could be three formats for a telephone services shopping cart. Each format contains the same information, but different aspects of that information are highlighted.
Format A: savings focused; highlights the savings that can be achieved by bundling features into packages.
Format B: cost focused; highlights the packages with minimal features for those concerned with reducing their phone bill.
Format C: technology focused; highlights new technology and features and offers feature rich packages.

Step 106 is performed if the customer data does not match an existing model. In this case, a default format is selected.

In Step 107, web content corresponding to the selected model is downloaded to the web browser residing on the customer's computer 10. The downloaded content is either the customized format or the default format.

1. A method of providing web site content to a web site customer, comprising the steps of:
collecting customer data about the customer's demographics and commercial preferences during one or more prior visits by the customer to the web site;
storing customer models in a models database accessible by a web site host;
storing a number of alternative web content formats, including a default format, in a content database accessible by the web site host;
receiving a web site request from the customer;
identifying the customer;
accessing the customer's customer data, based on the identifying step;
determining whether the customer data matches one of the customer models;
if the customer data matches a model, selecting a web content format corresponding to that model;
if the customer data does not match a model, selecting the default format; and
downloading web content corresponding to the selected web content format to the customer's web browser.

2. A method of providing web site content to a user of a web browser, comprising the steps of:
collecting customer data about the user's consumer preferences during one or more visits by the user to the web site;
storing customer models in a models database accessible by a web site host;
storing a number of alternative web content formats in a content database accessible by the web site host;
receiving a web site content request from the user;
identifying the user;
accessing the user's customer data, based on the identifying step;
matching the user's customer data to one of the customer models;
selecting a web content format corresponding to the model matched in the preceding step; and
downloading web content corresponding to the selected web content format to the web browser.

3. The method of claim 2, wherein at least one of the models is a savings focused model.

4. The method of claim 2, wherein at least one of the models is a cost focused model.

5. The method of claim 2, wherein at least one of the models is a technology focused model.

6. The method of claim 2, wherein at least one of the web content formats is a savings focused format.

7. The method of claim 2, wherein at least one of the web content formats is a cost focused format.

8. The method of claim 2, wherein at least one of the web content formats is a technology focused format.

9. The method of claim 2, wherein the web content format determines at least the arrangement of the web content.

10. The method of claim 2, wherein the web content format determines at least the information contained in the web site.

11. The method of claim 2, wherein the web content format determines at least the visual aspects of the web site.

12. The method of claim 2, wherein the matching step is performed while the user is on line to the web site.

13. The method of claim 2, wherein the collecting step is performed while the user is on line to the web site.

14. A system for providing web site content to a user of a web browser, comprising:
a customer data database operable to store data about the user's consumer preferences;
a models database operable to store a number of customer models;
a web content database operable to store a number of alternative web content formats for the web site; and
a web site host operable to access the customer data database, the models database, and the web content database, and further operable to: receive an identifier of each user that accesses the web site; to assign the user to a model, based on the user's customer data; to match the model to a web content format, and to download the matched web content format to the user's web browser.

15. The system of claim 14, wherein the models database stores one or more customer models from the following groups: cost focused, savings focused, and technology focused.

16. The system of claim 14, wherein the web content format database stores one or more web content formats from the following groups: cost focused, savings focused, and technology focused.

17. The system of claim 14, wherein the web site host is operable to collect customer data during visits of customers to the web site.

18. The system of claim 14, wherein at least one of the web content formats is a default format.

19. The system of claim 14, wherein the web site host assign the user to a model and matches the model to a web content format while the user is on-line to a web site.
